(19) United States
(12) Patent Application Publication
(10) Pub. No.: US 2025/0159609 A1
(43) Pub. Date: May 15, 2025

(54) METHOD FOR MONITORING DOWNLINK CHANNEL, APPARATUS AND NON-TRANSITORY COMPUTER-READABLE STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/838,677

(22) PCT Filed: Feb. 16, 2022
(86) PCT No.: PCT/CN2022/076531

§ 371 Date: Aug. 15, 2024

(51) Int. Cl. H04W 52/02; H04W 68/02; H04W 72/232; H04W 76/27

(52) U.S. Cl. CPC H04W 52/0235; H04W 68/02; H04W 72/232; H04W 76/27

(57) ABSTRACT

The present disclosure provides a method for monitoring a downlink channel, an apparatus, and a non-transitory computer-readable storage medium. The method is performed by a user device and includes receiving a wake-up signal and monitoring a downlink channel after a set moment. The set moment is a moment after a first moment, and the first moment is a moment when the wake-up signal is received.

### CROSS-REFERENCE

The present application is a U.S. National Stage of International Application No. PCT/CN2022/076531, filed on Feb. 16, 2022, the entire content of which is incorporated herein by reference for all purposes.

### TECHNICAL FIELD

The present disclosure relates to a field of wireless communication technology, and more particularly, to a method for monitoring a downlink channel, an apparatus, and a non-transitory readable storage medium.

### BACKGROUND

In wireless communication technology, such as in 5th Generation Mobile Communication Technology (5G), a transceiver may be put into a sleep state in order to save power consumption of a User Equipment (UE).

How to monitor the downlink channel when the UE is awakened by the WUS signal is an issue required to be addressed.

### SUMMARY

The present disclosure provides a monitoring method, an apparatus, and a non-transitory computer-readable storage medium.

A first aspect provides a method for monitoring a downlink channel, performed by a user device and includes:
receiving a wake-up signal WUS; and
monitoring a downlink channel after a set moment, where the set moment is a moment after a first moment, and the first moment is a moment when the wake-up signal is received.

A second aspect provides a communication apparatus including a processor and a memory, where the memory is configured to store a computer program, and the processor is configured to execute the computer program to implement the first aspect or any of the designs of the first aspect.

A third aspect provides a non-transitory computer-readable storage medium, where the non-transitory computer-readable storage medium has instructions (or computer programs, programs) stored thereon, and when the instructions are called and executed on a computer, the computer is caused to implement the first aspect described above or any of the designs of the first aspect.

### BRIEF DESCRIPTION OF THE DRAWINGS

The accompanying drawings described herein are used to provide a further understanding of embodiments of the present disclosure and constitute a part of the present disclosure. The embodiments of the embodiments of the present disclosure and their descriptions are used to explain the embodiments of the present disclosure and do not constitute improper limitations to the embodiments of the present disclosure. In the accompanying drawings:

The accompanying drawings, which are incorporated in and constitute a part of this specification, illustrate embodiments consistent with the present disclosure and, together with the description, serve to explain the principles of the present disclosure.

FIG. 1 is a schematic diagram of a wireless communication system architecture provided in an embodiment of the present disclosure;

FIG. 2 is a flowchart of a method for monitoring a downlink channel according to an embodiment;

FIG. 3 is a flowchart of a method for monitoring a downlink channel according to an embodiment;

FIG. 4 is a flowchart of a method for monitoring a downlink channel according to an embodiment;

FIG. 5 is a flowchart of a method for monitoring a downlink channel according to an embodiment;

FIG. 6 is a flowchart of a method for monitoring a downlink channel according to an embodiment;

FIG. 7 is a flowchart of a method for monitoring a downlink channel according to an embodiment;

FIG. 8 is a flowchart of a method for monitoring a downlink channel according to an embodiment;

FIG. 9 is a flowchart of a method for monitoring a downlink channel according to an embodiment;

FIG. 10 is a flowchart of a method for monitoring a downlink channel according to an embodiment;

FIG. 11 is a structural diagram of an apparatus for monitoring a downlink channel according to an embodiment;

FIG. 12 is a structural diagram of an apparatus for monitoring a downlink channel according to an embodiment.

### DETAILED DESCRIPTION

The embodiments of the present disclosure are further described with reference to the accompanying drawings and the detailed description.

The embodiments are described in detail here, examples of which are illustrated in the accompanying drawings. When the following description involves the accompanying drawings. unless otherwise indicated, the same numbers in different drawings represent the same or similar elements. The embodiments described in the following embodiments do not represent all embodiments consistent with the embodiments of the present disclosure. On the contrary, they are merely examples of apparatus and methods consistent with some aspects of the present disclosure as detailed in the appended claims.

The terms used in the present disclosure are for the purpose of describing particular examples only, and are not intended to limit the present disclosure. Terms determined by “a,” “the” and “said” in their singular forms in the present disclosure and the appended claims are also intended to include plurality or multiple, unless clearly indicated otherwise in the context. It should also be understood that the term “and/or” as used herein is and includes any and all possible combinations of one or more of the associated listed items.

It should be understood that, although terms “first,” “second,” “third” and the like may be used in the present disclosure to describe various information, such information should not be limited to these terms. These terms are only used to distinguish one category of information from another. For example, without departing from the scope of the present disclosure, first information may be referred as second information; and similarly, second information may also be referred as first information. Depending on the context, the word “if” and “whether” as used herein may be interpreted as “when” or “upon” or “in response to determining”.

The embodiments of the present disclosure are described in detail below. Examples of the embodiments are illustrated in the accompanying drawings where the same or similar numbers throughout indicate the same or similar elements. The embodiments described below by reference to the accompanying drawings are illustrative and are intended to interpret the present disclosure and are not to be construed as a limitation of the present disclosure.

When the UE is in Radio Resource Control (RRC) idle or inactive state, the UE periodically monitors a paging message and may enter an RRC connected state for normal communication upon receiving the paging message. The paging message is carried in the Physical Downlink Shared Channel (PDSCH) and needs to be scheduled with downlink control information (DCI) scrambled by a Paging Radio Network Temporary ID (P-RNTI). For one UE, its corresponding paging occasion (PO) occurs periodically, and a plurality of UEs may use the same set of periodic PO resources, and that is, the DCI sent in one PO may be received by the plurality of UEs corresponding to the PO.

Operations performed by the UE to monitor the paging message are as follows:

The UE monitors whether there is a DCI scrambled by using the P-RNTI in a corresponding PO of the UE, if the DCI scrambled by the P-RNTI is monitored in the PO, and a Short Messages Indicator information field in the DCI shows that the DCI schedules a PDSCH including a paging message, the UE needs to receive and demodulate the PDSCH according to the indication of the DCI, where the PDSCH includes an ID of the UE being paging.

If the UE finds, after receiving the PDSCH, that the ID of the UE is not carried in this PDSCH, the UE is not paged. If the UE, after receiving the PDSCH, finds that the ID of the UE is carried in this PDSCH, the UE is paged, and that is, the UE receives the paging message. If the UE does not monitor the DCI scrambled by the R-RNTI in its corresponding PO, or if there is such the DCI but the Short Messages Indicator information field in this DCI shows that the DCI does not schedule a PDSCH including the paging message, the UE does not receive and demodulate the PDSCH. When the UE is in an RRC connected state, this UE needs to monitor and receive downlink information, including PDCCH/PDMSH/downlink reference signal, etc.

The network device may send a multicast signal, and the multicast signal includes a wake-up signal (WUS). The same WUS may indicate the signal to a plurality of UEs, for example, the WUS includes 16 bits, corresponding to 16 UEs, and each bit corresponds to one UE. When a corresponding bit of one UE is 1, which indicates wake-up, and the UE turns on a main transceiver to receive a downlink signal; when a corresponding bit of the UE is 0, which indicates no wake-up, and the UE keeps the sleep state of the main transceiver.

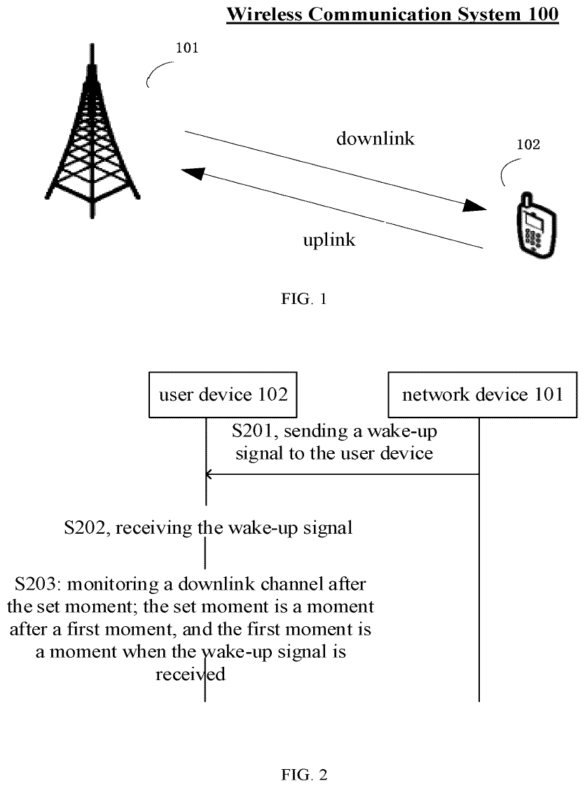

As shown in FIG. 1, a method for monitoring a downlink channel provided by embodiments of the present disclosure may be applied to a wireless communication system 100, which may include, but is not limited to, a network device 101 and a user device 102. The user device 102 is configured to support carrier aggregation, and the user device 102 may be connected to a plurality of carrier units of the network device 101, the plurality of carrier units including one primary carrier unit and one or more secondary carrier units.

It should be understood that the wireless communication system 100 may be applicable to both low frequency and high frequency scenarios. Application scenarios of the wireless communication system 100 include, but are not limited to, a long term evolution (LTE) system, an LTE frequency division duplex (FDD) system, an LTE time division duplex (TDD) system, a worldwide interoperability for microwave access (WiMAX) communication system, a cloud radio access network (CRAN) system, a future 5th-generation (5G) system, a new radio (NR) communication system or a future evolution public land mobile network (PLMN) system, etc.

The user device 102 shown above may be user equipment (UE), a terminal, an access terminal, a terminal unit, a terminal station, a mobile station (MS), a remote station, a remote terminal, a mobile terminal, a wireless communication device, a terminal agent or a user device. The user device 102 may has a wireless transceiver function, and is capable of communicating (e.g., wirelessly communicating) with one or more network devices 101 of one or more communication systems, and accepting network service(s) provided by the network device(s) 101 including but not limited to the illustrated base station.

The user device 102 may be a cellular phone, a cordless phone, a session initiation protocol (SIP) phone, a wireless local loop (WLL) station, a personal digital assistant (PDA) device, a handheld device with a wireless communication capability, a computing device or other processing device connected to a wireless modem, an in-vehicle device, a wearable device, a user device in a future 5G network or a user device in a future evolution PLMN network.

The network device 101 may be an access network device (or referred to as an access network site). The access network device refers to a device providing a network access function, such as a radio access network (RAN) base station. The network device may specifically include a base station (BS) device, or include the base station device and a radio resource management device configured to control the base station device. The network device may further include a relay station (a relay device), an access point, and a base station in the future 5G network, a base station in the future evolution PLMN network, or an NR base station. The network device may be a wearable device or an in-vehicle device. The network device may also be a communication chip with a communication module.

For example, the network device 101 includes, but is not limited to, a next-generation base station (gnodeB, gNB) in 5G, an evolved node B (eNB) in the LTE system, a radio network controller (RNC), a node B (NB) in a wideband code division multiple access (WCDMA) system, a radio controller under the CRAN system, a base station controller (BSC), a base transceiver station (BTS) in a global system for mobile communications (GSM) or code division multiple access (CDMA) system, a home base station (for example, a home evolved nodeB, or a home node B (HNB)), a baseband unit (BBU), a transmitting and receiving point (TRP), a transmitting point (TP) or a mobile switching center.

The embodiments of the present disclosure provide a method for monitoring a downlink channel. FIG. 2 is a flowchart of a method for monitoring a downlink channel according to an embodiment, as shown in FIG. 2. The method includes steps S201-S203:
in step S201, a network device 101 sends a wake-up signal
in step S202, a user device 102 receives the wake-up signal;
in step S203: a downlink channel after the set moment is monitored; the set moment is a moment after a first moment, and the first moment is a moment when the wake-up signal is received.

In an embodiment, the set moment corresponds to a radio resource control RRC state of the user device.

For example, the RRC state of the user device is an RRC idle state or an RRC connected state; the set moment corresponding to the RRC idle state is different from the set moment for the RRC connected state.

In the embodiments of the present disclosure, the user device 102 receives the wake-up signal sent by the network device 101. After receiving the wake-up signal, the user device monitors the downlink channel and takes the moment when the wake-up signal is received as a start moment for starting to monitor the downlink channel, such that the processing flow of the user device is concise and reasonable.

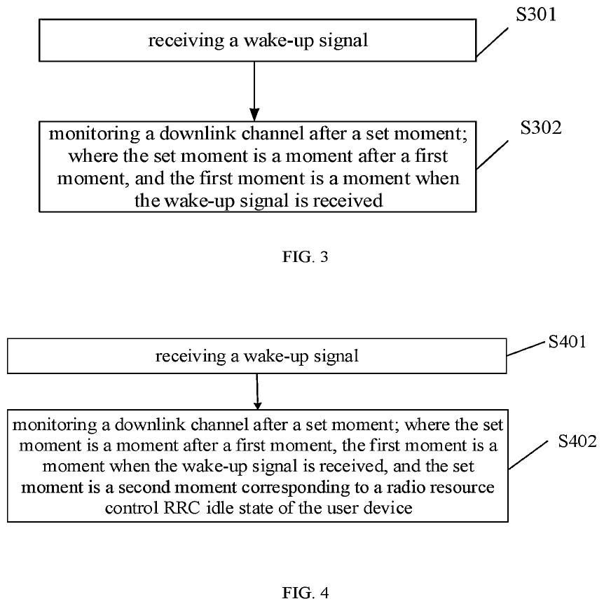

The embodiments of the present disclosure provide a method for monitoring a downlink channel, which is performed by a user device, and the method may be performed independently or in combination with any other embodiment of the embodiments of the present disclosure. FIG. 3 is a flowchart of a method for monitoring a downlink channel according to an embodiment. As shown in FIG. 3, the method includes steps S301 and S302:
in step S301, a wake-up signal is received;
in step S302: a downlink channel after a set moment is monitored; where the set moment is
a moment after a first moment, and the first moment is a moment when the wake-up signal is received.

In an embodiment, the set moment corresponds to a radio resource control RRC state of the user device.

For example, the RRC state of the user device is an RRC idle state or an RRC connected state; the set moment corresponding to the RRC idle state is different from the set moment for the RRC connected state.

In an embodiment, the set moment is a second moment corresponding to a radio resource control RRC idle state of the user device.

In an embodiment, the monitoring the downlink channel after the set moment includes:
monitoring a paging occasion within a set range, where the paging occasion within the set range includes latest N paging occasions after the second moment, where N is a positive integer greater than or equal to 1; and
in response to that a paging occasion with a paging DCI firstly occurring within the set range is monitored, not monitoring a subsequent paging occasion.

In an embodiment, the monitoring the downlink channel after the set moment includes:
monitoring a paging occasion within a set range, where the paging occasion within the set range includes latest N paging occasions after the second moment, where N is a positive integer greater than or equal to 1; and
in response to that a paging occasion with a paging DCI firstly occurring within the set
range is monitored and the paging DCI schedules a paging message including an identifier of the user device, not monitoring a subsequent paging occasion.

In an embodiment, the monitoring the downlink channel after the set moment includes:
monitoring one latest paging occasion after the second moment.

In an embodiment, the method further includes;
not monitoring a paging occasion after a third moment, where the third moment is a moment after the second moment.

In an embodiment, the N is specified by a protocol or configured by a network device.

In an embodiment, an interval between the first moment and the second moment is specified by a protocol or configured by a network device. In an embodiment, an interval between the first moment and the third moment or an interval between the second moment and the third moment is specified by a protocol or configured by a network device.

In an embodiment, the set moment is a fourth moment corresponding to a radio resource control RRC connected state of the user device.

In an embodiment, the method further includes:
if the downlink channel is not monitored before a fifth moment, not monitoring the downlink channel until a wake-up signal is received again; where the fifth moment is a moment after the fourth moment.

In an embodiment, the downlink channel includes DCI, a PDSCH scheduled using DCI.

In an embodiment, the downlink channel includes DCI, a PDSCH scheduled using DCI, a PDSCH scheduled not using DCI.

In an embodiment, an interval between the first moment and the fourth moment is specified by a protocol or configured by a network device.

In an embodiment, the method further includes:
reporting, to a network device, an interval between the fourth moment and the first moment, or
reporting, to a network device, a downlink channel monitoring capability parameter supported by the user device when the user device uses the WUS, where the downlink channel monitoring capability parameter includes an interval between the fourth moment and the first moment.

In an embodiment, an interval between the fifth moment and the fourth moment or an interval between the fifth moment and the first moment is specified by a protocol or configured by a network device.

In an embodiment, the method further includes: reporting, to a network device, an interval between the fifth moment and the fourth moment or an interval between the fifth moment and the first moment, or
reporting, to a network device, a downlink channel monitoring capability parameter supported by the user device when the user device uses the WUS, where the downlink channel monitoring capability parameter includes an interval between the fifth moment and the first moment or an interval between the fifth moment and the fourth moment.

In the embodiments of the present disclosure, the user device receives the wake-up signal, and the moment when the wake-up signal is received is the first moment, the user device monitors the downlink channel after the first moment, and takes the moment of receiving the wake-up signal as a start moment for starting to monitor the downlink channel, such that the processing flow of the user device is concise and reasonable.

The embodiments of the present disclosure provide a method for monitoring a downlink channel, which is performed by a user device, and the method may be performed independently or in combination with any other embodiment of the embodiments of the present disclosure. FIG. 4 is a flowchart of a method for monitoring a downlink channel according to an embodiment. As shown in FIG. 4, the method includes steps S401 and S402:
in step S401, a wake-up signal is received;
in step S402: a downlink channel after a set moment is monitored; where the set moment is a moment after a first moment, the first moment is a moment when the wake-up signal is received, and the set moment is a second moment corresponding to a radio resource control RRC idle state of the user device.

In an embodiment, the second moment is specified by a protocol or configured by a network device.

In an embodiment, an interval between the first moment and the second moment is specified by a protocol or configured by a network device.

In the embodiments of the present disclosure, the user device receives the wake-up signal and monitors the downlink channel after the set moment, and the set moment is the second moment corresponding to a radio resource control RRC idle state of the user device, and the moment when the wake-up signal is received is used as a start moment for starting to monitor the downlink channel, such that the processing flow of the user device is concise and reasonable.

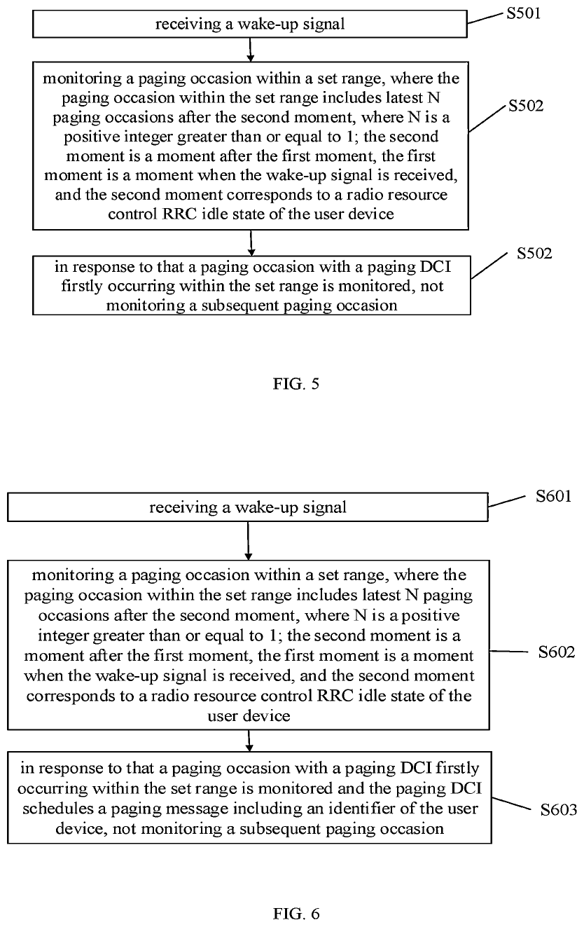

The embodiments of the present disclosure provide a method for monitoring a downlink channel, which is performed by a user device, and the method may be performed independently or in combination with any other embodiment of the embodiments of the present disclosure. FIG. 5 is a flowchart of a method for monitoring a downlink channel according to an embodiment. As shown in FIG. 5, the method includes steps S501 to S503:
in step S501, a wake-up signal is received;
in step S502: a paging occasion within a set range is monitored, where the paging occasion within the set range includes latest N paging occasions after the second moment, where N is a positive integer greater than or equal to 1; the second moment is a moment after the first moment, the first moment is a moment when the wake-up signal is received, and the second moment corresponds to a radio resource control RRC idle state of the user device.
in step S503, in response to that a paging occasion with a paging DCI firstly occurring within the set range is monitored, a subsequent paging occasion is not monitored.

In an embodiment, the N is specified by a protocol or configured by a network device.

In an embodiment, an interval between the first moment and the second moment is specified by a protocol or configured by a network device.

In an embodiment, the set range corresponds to a set duration.

In an embodiment, the set range corresponds to a number of times N.

In the embodiments of the present disclosure, after the second moment, the UE monitors at most the latest N POs. If a paging DCI is monitored in a certain PO, the UE no longer monitors a subsequent PO. In this embodiment, if a base station has a paging message required to be sent to the UE, the base station needs to schedule the paging message in the paging DCI detected by the UE for the first time.

In the embodiments of the present disclosure, when the UE is in the RRC idle state, the monitoring is only performed for a period of time after the second moment, which may save the processing capability of the UE.

The embodiments of the present disclosure provide a method for monitoring a downlink channel, which is performed by a user device, and the method may be performed independently or in combination with any other embodiment of the embodiments of the present disclosure. FIG. 6 is a flowchart of a method for monitoring a downlink channel according to an embodiment. As shown in FIG. 6, the method includes steps S601 to S603:
in step S601, a wake-up signal is received;
in step S602: a paging occasion within a set range is monitored, where the paging occasion within the set range includes latest N paging occasions after the second moment, where N is a positive integer greater than or equal to 1; the second moment is a moment after the first moment, the first moment is a moment when the wake-up signal is received, and the second moment corresponds to a radio resource control RRC idle state of the user device;
in step S603, in response to that a paging occasion with a paging DCI firstly occurring within the set range is monitored and the paging DCI schedules a paging message including an identifier of the user device, a subsequent paging occasion is not monitored.

In an embodiment, the N is specified by a protocol or configured by a network device.

In an embodiment, an interval between the first moment and the second moment is specified by a protocol or configured by a network device.

In an embodiment, the set range corresponds to a set duration. In an embodiment, the set range corresponds to a number of times N.

In the embodiments of the present disclosure, when the UE is in the RRC idle state, the monitoring is only performed for a period of time after the second moment, which may save the processing capability of the UE.

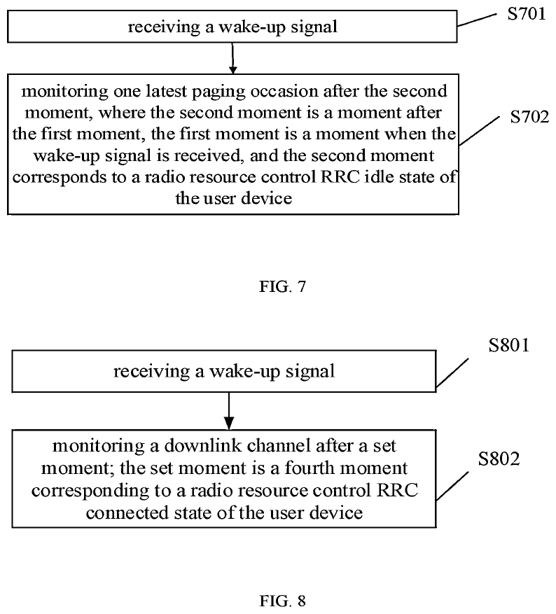

The embodiments of the present disclosure provide a method for monitoring a downlink channel, which is performed by a user device, and the method may be performed independently or in combination with any other embodiment of the embodiments of the present disclosure. FIG. 7 is a flowchart of a method for monitoring a downlink channel according to an embodiment. As shown in FIG. 7, the method includes steps S701 and S702:
in step S701, a wake-up signal is received;
in step S702, one latest paging occasion after the second moment is monitored, where the second moment is a moment after the first moment, the first moment is a moment when the wake-up signal is received, and the second moment corresponds to a radio resource control RRC idle state of the user device.

In an embodiment, an interval between the first moment and the second moment is specified by a protocol or configured by a network device.

In the embodiments of the present disclosure, when the UE is in the RRC idle state, the UE only monitors the latest paging occasion, the most recent paging occasion, after the second moment, which may greatly save the processing capacity of the UE.

The embodiments of the present disclosure provide a method for monitoring a downlink channel, which is performed by a user device, and the method may be performed independently or in combination with any other embodiment of the embodiments of the present disclosure. The method includes:
receiving a wake-up signal;
monitoring a downlink channel after a second moment and not monitoring a paging occasion after a third moment; where the second moment is a moment after the first moment, the first moment is a moment when the wake-up signal is received, and the second moment corresponds to a radio resource control RRC idle state of the user device; the third moment is a moment after the second moment. In an embodiment, an interval between the first moment and the second moment is specified by a protocol or configured by a network device.

In an embodiment, an interval between the first moment and the third moment or an interval between the second moment and the third moment is specified by a protocol or configured by a network device.

The embodiments of the present disclosure provide a method for monitoring a downlink channel, which is performed by a user device, and the method may be performed independently or in combination with any other embodiment of the embodiments of the present disclosure. FIG. 8 is a flowchart of a method for monitoring a downlink channel according to an embodiment. As shown in FIG. 8, the method includes steps S801 and S802:
in step S801, a wake-up signal is received;
in step S802: a downlink channel after a set moment is monitored; the set moment is a fourth moment corresponding to a radio resource control RRC connected state of the user device.

In an embodiment, an interval between the first moment and the fourth moment is specified by a protocol or configured by a network device.

In the embodiments of the present disclosure, the user device receives the wake-up signal and monitors the downlink channel after the set moment; the set moment is the fourth moment corresponding to the radio resource control RRC connected state of the user device, and the moment when the wake-up signal is received is used as a start moment for monitoring the downlink channel, such that the processing flow of the user device is concise and reasonable.

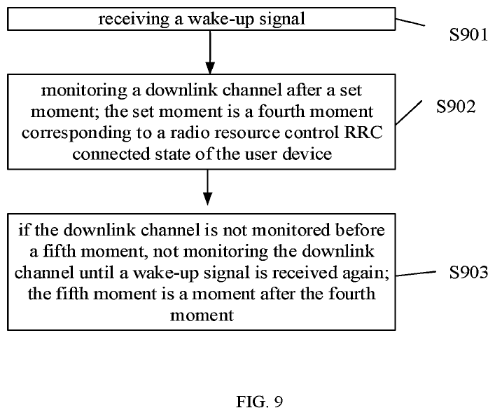

The embodiments of the present disclosure provide a method for monitoring a downlink channel, which is performed by a user device, and the method may be performed independently or in combination with any other embodiment of the embodiments of the present disclosure. FIG. 9 is a flowchart of a method for monitoring a downlink channel according to an embodiment. As shown in FIG. 9, the method includes steps S901-S903:
in step S901, a wake-up signal is received;
in step S902: a downlink channel after a set moment is monitored; the set moment is a fourth moment corresponding to a radio resource control RRC connected state of the user device;
in step S903, if the downlink channel is not monitored before a fifth moment, the downlink channel is not monitored until a wake-up signal is received again; the fifth moment is a moment after the fourth moment.

In an embodiment, the downlink channel includes DCI and a PDSCH scheduled using DCI.

In an embodiment, the downlink channel includes DCI, a PDSCH scheduled using DCI, a PDSCH scheduled not using DCI.

In an embodiment, an interval between the first moment and the fourth moment is specified by a protocol or configured by a network device.

In an embodiment, the fifth moment is specified by a protocol or configured by a network device.

In the embodiments of the present disclosure, the user device receives the wake-up signal and monitors the downlink channel after the set moment; the set moment is the fourth moment corresponding to the radio resource control RRC connected state of the user device, if the downlink channel is not monitored before a fifth moment, the downlink channel is not monitored until a wake-up signal is received again; when the UE is in the RRC connected state and no downlink channel is monitored within a set time period after the fourth moment, the downlink channel is monitored until the wake-up signal is received again, which may save the processing capability of the UE.

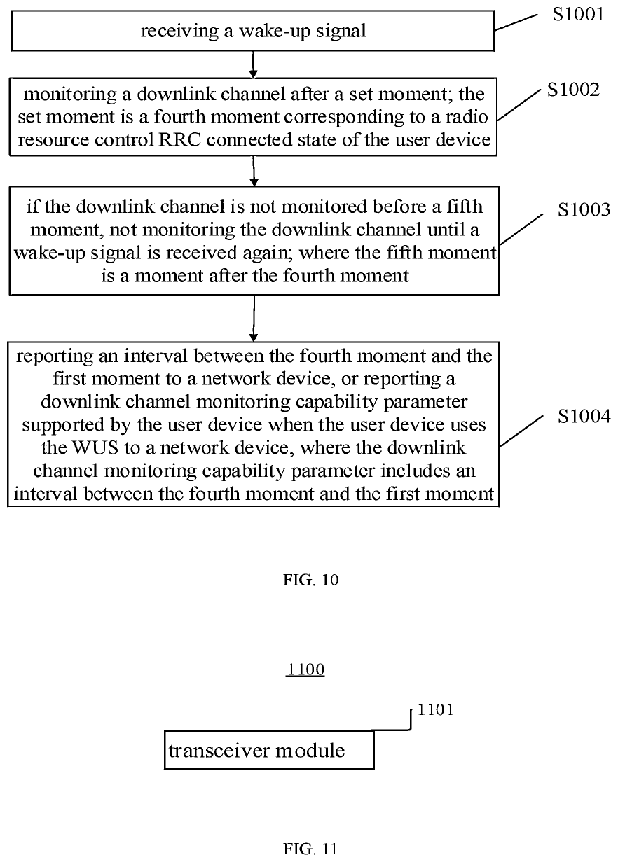

The embodiments of the present disclosure provide a method for monitoring a downlink channel, which is performed by a user device, and the method may be performed independently or in combination with any other embodiment of the embodiments of the present disclosure. FIG. 10 is a flowchart of a method for monitoring a downlink channel according to an embodiment. As shown in FIG. 10, the method includes steps S1001 to S1004:
in step S1001, a wake-up signal is received;
in step S1002; a downlink channel after a set moment is monitored; the set moment is a fourth moment corresponding to a radio resource control RRC connected state of the user device;
in step S1003, if the downlink channel is not monitored before a fifth moment, the downlink channel is not monitored until a wake-up signal is received again; the fifth moment is a moment after the fourth moment;
in step S1004, an interval between the fourth moment and the first moment is reported to a network device, or a downlink channel monitoring capability parameter supported by the user device when the user device uses the WUS is reported to a network device, where the downlink channel monitoring capability parameter includes an interval between the fourth moment and the first moment.

In an embodiment, the step S1004 further includes: reporting, to a network device, an interval between the fifth moment and the fourth moment or an interval between the fifth moment and the first moment, or reporting, to a network device, a downlink channel monitoring capability parameter supported by the user device when the user device uses the WUS, where the downlink channel monitoring capability parameter includes an interval between the fifth moment and the first moment or an interval between the fifth moment and the first moment.

Based on the same concept as the above method embodiments, embodiments of the present disclosure also provide a communication apparatus that may have a function of the user device 102 in the above method embodiments and be configured to perform steps provided by the user device 102 in the above embodiments. The function may be implemented in a form of hardware, in a form of software or in a form of hardware executing corresponding software. The hardware or software includes one or more modules corresponding to the function described above.

In an embodiment, the communication apparatus 1100 shown in FIG. 11 may serve as the user device 102 involved in the above method embodiments and perform the steps performed by the user device 102 in the above method embodiments.

The communication apparatus 1100 includes:
a transceiver module 1101, configured to receive a wake-up signal and configured to monitor a downlink channel after a set moment; where the set moment is a moment after a first moment, and the first moment is a moment when the wake-up signal is received.

In an embodiment, the set moment is a second moment corresponding to a radio resource control RRC idle state of the user device.

In an embodiment, the transceiver module 1101 is further configured to monitor a paging occasion within a set range, where the paging occasion within the set range includes latest N paging occasions after the second moment, where N is a positive integer greater than or equal to 1; and
not monitor a subsequent paging occasion in response to that a paging occasion with a paging DCI firstly occurring within the set range is monitored.

In an embodiment, the transceiver module 1101 is further configured to
monitor a paging occasion within a set range, where the paging occasion within the set range includes latest N paging occasions after the second moment, where N is a positive integer greater than or equal to 1; and
not monitor a subsequent paging occasion in response to that a paging occasion with a paging DCI firstly occurring within the set range is monitored and the paging DCI schedules a paging message including an identifier of the user device.

In an embodiment, the transceiver module 1101 is further configured to monitor one latest paging occasion after the second moment.

In an embodiment, the transceiver module 1101 is further configured to not monitor a paging occasion after a third moment, where the third moment is a moment after the second moment.

In an embodiment, the N is specified by a protocol or configured by a network device.

In an embodiment, an interval between the first moment and the second moment is specified by a protocol or configured by a network device.

In an embodiment, an interval between the first moment and the third moment or an interval between the second moment and the third moment is specified by a protocol or configured by a network device.

In an embodiment, the set moment is a fourth moment corresponding to a radio resource control RRC connected state of the user device.

In an embodiment, the transceiver module 1101 is further configured to if the downlink channel is not monitored before a fifth moment, not monitor the downlink channel until a wake-up signal is received again; where the fifth moment is a moment after the fourth moment.

In an embodiment, the downlink channel includes DCI, a PDSCH scheduled using the DCI.

In an embodiment, the downlink channel includes DCI, a PDSCH scheduled using DCI, a PDSCH scheduled not using DCI.

In an embodiment, an interval between the first moment and the fourth moment is specified by a protocol or configured by a network device.

In an embodiment, the transceiver module 1101 is further configured to report, to a network device, an interval between the fourth moment and the first moment, or
report, to a network device, a downlink channel monitoring capability parameter supported by the user device when the user device uses the WUS, where the downlink channel monitoring capability parameter includes an interval between the fourth moment and the first moment.

In an embodiment, an interval between the fifth moment and the fourth moment or an interval between the fifth moment and the first moment is specified by a protocol or configured by a network device.

In an embodiment, the transceiver module 1101 is further configured to report, to a network device, an interval between the fifth moment and the fourth moment or an interval between the fifth moment and the first moment, or report, to a network device, a downlink channel monitoring capability parameter supported by the user device when the user device uses the WUS, where the downlink channel monitoring capability parameter includes an interval between the fifth moment and the fourth moment or an interval between the fifth moment and the first moment.

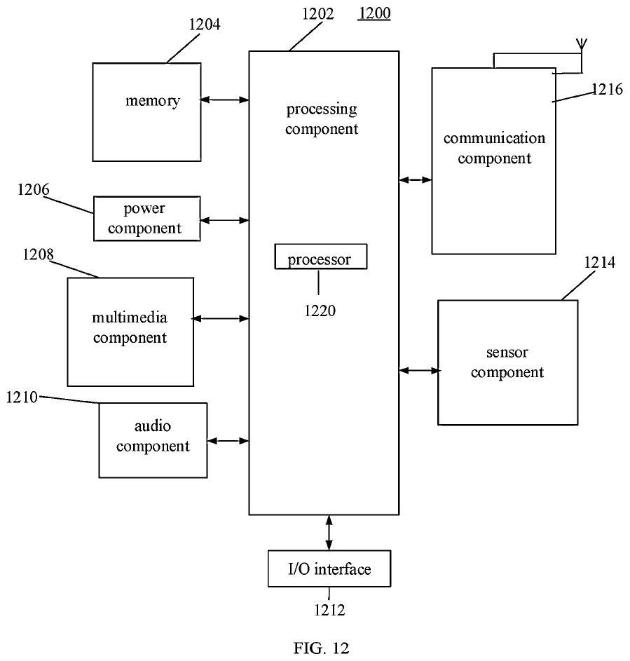

When the communication apparatus is a user device, its structure may also be shown in FIG. 12. FIG. 12 is a block diagram of an apparatus 1200 for monitoring a downlink channel, according to an embodiment. For example, the apparatus 1200 may be a mobile phone, a computer, a digital broadcast terminal, a message transceiver, a game console, a tablet device, a medical device, fitness equipment, a personal digital assistant or the like.

Referring to FIG. 12, the apparatus 1200 may include one or more following components: a processing component 1202, a memory 1204, a power component 1206, a multimedia component 1208, an audio component 1210, an input/output (I/O) interface 1212, a sensor component 1214 and a communication component 1216.

The processing component 1202 typically controls overall operations of the apparatus 1200, such as the operations associated with display, telephone calls, data communications, camera operations and recording operations. The processing component 1202 may include one or more processors 1220 to execute instructions to perform all or part of the steps in the above described methods. Moreover, the processing component 1202 may include one or more modules which facilitate the interaction between the processing component 1202 and other components. For example, the processing component 1202 may include a multimedia module to facilitate the interaction between the multimedia component 1208 and the processing component 1202.

The memory 1204 is configured to store various types of data to support the operation of the apparatus 1200. Examples of such data include instructions for any applications or methods operated on the apparatus 1200, contact data, phonebook data, messages, pictures, video, etc. The memory 1204 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1206 provides power to various components of the apparatus 1200. The power component 1206 may include a power management system, one or more power sources, and any other components associated with the generation, management, and distribution of power in the apparatus 1200.

The multimedia component 1208 includes a screen providing an output interface between the apparatus 1200 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes and gestures on the touch panel. The touch sensors may not only sense a boundary of a touch or swipe action, but also sense a period of time and a pressure associated with a touch or swipe action. In some embodiments, the multimedia component 1208 includes a front camera and/or a rear camera. The front camera and/or the rear camera may receive an external multimedia datum while the apparatus 1200 is in an operation mode, such as a photographing mode or a video mode. Each of the front and rear cameras may be a fixed optical lens system or have a focus and optical zoom capability.

The audio component 1210 is configured to output and/or input audio signals. For example, the audio component 1210 includes a microphone (MIC) configured to receive an external audio signal when the apparatus 1200 is in an operation mode, such as a call mode, a recording mode, and a voice recognition mode. The received audio signal may be further stored in the memory 1204 or transmitted via the communication component 1216. In some embodiments, the audio component 1210 further includes a speaker to output audio signals.

The I/O interface 1212 provides an interface between the processing component 1202 and peripheral interface modules, such as a keyboard, a click wheel, buttons, and the like. The buttons may include, but are not limited to, a home button, a volume button, a starting button, and a locking button. The buttons may include, but are not limited to, a home button, a volume button, a starting button, and a locking button.

The sensor component 1214 includes one or more sensors to provide status assessments of various aspects of the apparatus 1200. For instance, the sensor component 1214 may detect an open/closed status of the apparatus 1200, relative positioning of components, e.g., the display and the keypad, of the apparatus 1200 a change in position of the apparatus 1200 or a component of the apparatus 1200, a presence or absence of user's contact with the apparatus 1200, an orientation or an acceleration/deceleration of the apparatus 1200, and a change in temperature of the apparatus 1200. The sensor component 1214 may include a proximity sensor configured to detect the presence of nearby objects without any physical contact. The sensor component 1214 may also include a light sensor, such as a CMOS or CCD image sensor, for use in imaging applications. In some embodiments, the sensor component 1214 may also include an accelerometer sensor, a gyroscope sensor, a magnetic sensor, a pressure sensor or a temperature sensor.

The communication component 1216 is configured to facilitate communication, wired or wirelessly, between the apparatus 1200 and other devices. The apparatus 1200 can access a wireless network based on a communication standard, such as WiFi, 4G; or 5G; or a combination thereof. In an embodiment, the communication component 1216 receives a broadcast signal or broadcast associated information from an external broadcast management system via a broadcast channel. In an embodiment, the communication component 1216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In embodiments, the apparatus 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In embodiments, there is also provided a non-transitory computer-readable storage medium including instructions, such as included in the memory 1204, executable by the processor 1220 in the apparatus 1200, for performing the above-described methods. For example, the non-transitory computer-readable storage medium may be a ROM, a RAM, a CD-ROM, a magnetic tape, a floppy disc, an optical data storage device, and the like.

The present disclosure provides a monitoring method, an apparatus, and a non-transitory readable storage medium.

A first aspect provides a method for monitoring a downlink channel, performed by a user device and includes:
receiving a wake-up signal WUS; and
monitoring a downlink channel after a set moment; where the set moment is a moment after a first moment, and the first moment is a moment when the wake-up signal is received.

In the method, the user device receives a wake-up signal, a moment when the the wake-up signal is received is a first moment, and the user device monitors a downlink channel after the first moment and takes the moment when the wake-up signal is received as a start moment for starting to monitor the downlink channel, such that the processing flow of the user device is concise and reasonable.

In an embodiment, the set moment is a second moment corresponding to a radio resource control RRC idle state of the user device.

In an embodiment, the monitoring the downlink channel after the set moment includes: monitoring a paging occasion within a set range, where the paging occasion within the set range includes latest N paging occasions after the second moment, where N is a positive integer greater than or equal to 1; and in response to that a paging occasion with a paging DCI firstly occurring within the set range is monitored, not monitoring a subsequent paging occasion.

In an embodiment, the monitoring the downlink channel after the set moment includes: monitoring a paging occasion within a set range, where the paging occasion within the set range includes latest N paging occasions after the second moment, where N is a positive integer greater than or equal to 1; and in response to that a paging occasion with a paging DCI firstly occurring within the set range is monitored and the paging DCI schedules a paging message including an identifier of the user device, not monitoring a subsequent paging occasion.

In an embodiment, the monitoring the downlink channel after the set moment includes: monitoring one latest paging occasion after the second moment.

In an embodiment, the method further includes: not monitoring a paging occasion after a third moment, where the third moment is a moment after the second moment.

In an embodiment, the N is specified by a protocol or configured by a network device.

In an embodiment, an interval between the first moment and the second moment is specified by a protocol or configured by a network device.

In an embodiment, an interval between the first moment and the third moment or an interval between the second moment and the third moment is specified by a protocol or configured by a network device.

In an embodiment, the set moment is a fourth moment corresponding to a radio resource control RRC connected state of the user device.

In an embodiment, the method further includes: if the downlink channel is not monitored before a fifth moment, not monitoring the downlink channel until a wake-up signal is received again; where the fifth moment is a moment after the fourth moment.

In an embodiment, the downlink channel includes DCI, a PDSCH scheduled using DCI.

In an embodiment, the downlink channel includes DCI, a PDSCH scheduled using DCI, a PDSCH scheduled not using DCI.

In an embodiment, an interval between the first moment and the fourth moment is specified by a protocol or configured by a network device.

In an embodiment, the method further includes: reporting, to a network device, an interval between the fourth moment and the first moment, or reporting, to a network device, a downlink channel monitoring capability parameter supported by the user device when the user device uses the WUS, where the downlink channel monitoring capability parameter includes an interval between the fourth moment and the first moment.

In an embodiment, an interval between the fifth moment and the fourth moment or an interval between the fifth moment and the first moment is specified by a protocol or configured by a network device.

In an embodiment, the method further includes: reporting, to a network device, an interval between the fifth moment and the fourth moment or an interval between the fifth moment and the first moment, or reporting, to a network device, a downlink channel monitoring capability parameter supported by the user device when the user device uses the WUS, where the downlink channel monitoring capability parameter includes an interval between the fifth moment and the fourth moment or an interval between the fifth moment and the first moment.

A second aspect provides a communication apparatus, the communication apparatus may be used to perform steps performed by a user device in the first aspect described above or in any of the designs of the first aspect. The user device may implement by a hardware structure or a software module.

When implementing the communication apparatus shown in the first aspect through the software module, the communication apparatus may include a receiving module.
a transceiver module, configured to receive a wake-up signal and configured to monitor a downlink channel after a set moment; where the set moment is a moment after a first moment, and the first moment is a moment when the wake-up signal is received.

A third aspect provides a communication apparatus including a processor and a memory, where the memory is configured to store a computer program; and the processor is configured to execute the computer program to implement the first aspect or any of the designs of the first aspect.

A fourth aspect provides a non-transitory computer-readable storage medium, the non-transitory computer-readable storage medium has instructions (or computer programs, programs) stored thereon, when the instructions are called and executed on a computer, the computer is caused to implement the first aspect described above or any of the designs of the first aspect.

### INDUSTRIAL APPLICABILITY

The user device receives a wake-up signal, a moment when the the wake-up signal is received is a first moment, and the user device monitors a downlink channel after the first moment and takes the moment when the wake-up signal is received as a start moment for starting to monitor the downlink channel, such that the processing flow of the user device is concise and reasonable.

1. A method for monitoring a downlink channel, performed by a user device, the method comprising:
receiving a wake-up signal (WUS); and
monitoring a downlink channel after a set moment, wherein the set moment is a moment after a first moment, and wherein the first moment is a moment when the wake-up signal is received.

2. The method according to claim 1, wherein the set moment is a second moment corresponding to a radio resource control (RRC) idle state of the user device.

3. The method according to claim 2, wherein the monitoring the downlink channel after the set moment comprises:
monitoring a paging occasion within a set range, wherein the paging occasion within the set range comprises latest N paging occasions after the second moment, where N is a positive integer greater than or equal to 1; and
in response to that a paging occasion with a paging downlink control information (DCI) occurring within the set range is monitored, determining not to monitor a subsequent paging occasion.

4. The method according to claim 2, wherein the monitoring the downlink channel after the set moment comprises:
monitoring a paging occasion within a set range, wherein the paging occasion within the set range comprises latest N paging occasions after the second moment, where N is a positive integer greater than or equal to 1: and
in response to that a paging occasion with a paging DCI occurring within the set range is monitored and the paging DCI schedules a paging message comprising an identifier of the user device, determining not to monitor a subsequent paging occasion.

5. The method according to claim 2, wherein the monitoring the downlink channel after the set moment comprises:
monitoring one latest paging occasion after the second moment.

6. The method according to claim 2, further comprising:
determining not to monitor a paging occasion after a third moment, wherein the third moment is a moment after the second moment.

7. The method according to claim 3, wherein the N is specified by a protocol or configured by a network device.

8. The method according to claim 2, wherein an interval between the first moment and the second moment is specified by a protocol or configured by a network device.

9. The method according to claim 6, wherein an interval between the first moment and the third moment or an interval between the second moment and the third moment is specified by a protocol or configured by a network device.

10. The method according to claim 1, wherein the set moment is a fourth moment corresponding to an RRC connected state of the user device.

11. The method according to claim 10, further comprising:
in response to not monitoring the downlink channel before a fifth moment, determining not to monitor the downlink channel until the wake-up signal is received again, wherein the fifth moment is a moment after the fourth moment.

12. The method according to claim 11, wherein the downlink channel comprises DCI, or a Physical Downlink Shared Channel (PDSCH) scheduled using DCI.

13. The method according to claim 11, wherein the downlink channel comprises at least one of following: DCI, a PDSCH scheduled using DCI, or a PDSCH scheduled not using DCI.

14. The method according to claim 10, wherein an interval between the first moment and the fourth moment is specified by a protocol or configured by a network device.

15. The method according to claim 10, further comprising:
reporting, to a network device, an interval between the fourth moment and the first moment; or
reporting, to a network device, a downlink channel monitoring capability parameter supported by the user device in a case that the user device uses the WUS, wherein the downlink channel monitoring capability parameter comprises an interval between the fourth moment and the first moment.

16. The method according to claim 11, wherein an interval between the fifth moment and the fourth moment or an interval between the fifth moment and the first moment is specified by a protocol or configured by a network device.

17. The method according to claim 11, further comprising:
reporting, to a network device, an interval between the fifth moment and the fourth moment or an interval between the fifth moment and the first moment; or
reporting, to a network device, a downlink channel monitoring capability parameter supported by the user device in a case that the user device uses the WUS, wherein the downlink channel monitoring capability parameter comprises an interval between the fifth moment and the fourth moment or an interval between the fifth moment and the first moment.

18. (canceled)

19. A communication apparatus comprising a processor and a memory, wherein
the memory is configured to store a computer program, and
the processor is configured to:
receive a wake-up signal (WUS); and
monitor a downlink channel after a set moment, wherein the set moment is a moment after a first moment, and wherein the first moment is a moment when the wake-up signal is received.

20. (canceled)

21. The communication apparatus according to claim 19, wherein the set moment is a second moment corresponding to a radio resource control (RRC) idle state of the user device.

22. A non-transitory computer-readable storage medium storing instructions which, when executed on a computer, cause the computer to:
receive a wake-up signal (WUS); and
monitor a downlink channel after a set moment; wherein the set moment is a moment after a first moment, and wherein the first moment is a moment when the wake-up signal is received.
